(19) United States
(12) Patent Application Publication
(10) Pub. No.: US 2024/0054340 A1
(43) Pub. Date: Feb. 15, 2024

(54) FINDING A STATIONARY POINT OF A LOSS FUNCTION BY AN ITERATIVE ALGORITHM USING A VARIABLE LEARNING RATE VALUE

(71) Applicant: DeepMind Technologies Inc., London (GB)

(72) Inventors: Mihaela Rosca, London (GB); Benoit Richard Umbert Dherin, Oakland, CA (US); Yan Wu, St. Albans (GB); Chongli Qin, London (GB)

(21) Appl. No.: 18/232,291

(22) Filed: Aug. 9, 2023

Related U.S. Application Data
(60) Provisional application No. 63/396,801, filed on Aug. 10, 2022.

(51) Int. Cl. G06N 3/08

(52) U.S. Cl. CPC G06N 3/08

(57) ABSTRACT

A computer-implemented method for determining, for a loss function which is a function of a parameter vector comprising a plurality of parameters, values for the parameters for which the parameter vector is a stationary point of the loss function, comprising: determining initial values for the parameters; and repeatedly updating the parameters by: (a) determining at least one drift value; (b) determining at least one learning rate value by evaluating a learning rate function based on, and having an inverse relationship with, the at least one drift value; (c) determining respective updates to the parameters based upon a product of the at least one learning rate value and a gradient of the loss function with respect to the respective parameter for current values of the parameters; and (d) updating the parameters based upon the determined respective updates.

### CROSS-REFERENCE TO RELATED APPLICATION

This application claims priority under 35 U.S.C. 119 to Provisional Application No. 63/396,801, filed Aug. 10, 2022, which is incorporated by reference.

### BACKGROUND

This specification relates to determining, for a loss function which is a function of a parameter vector comprising a plurality of parameters, values for the parameters for which the parameter vector is a stationary point (e.g. a minimum) of the loss function. In particular, the parameters may be parameters defining a neural network, and the loss function may be a function indicative of how well the neural network performs a computational task.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations for performing a method to find a stationary point of a loss function which is a function of a parameter vector comprising, or consisting of, a plurality of parameters.

In an example, the parameters may be the parameters of a neural network, and the loss function may be a loss function characterizing how well the neural network performs a computational task, e.g. with higher values of the loss function indicating that the computational task is performed less well. In this case, the stationary point is typically a minimum of the loss function. However, the method is applicable more generally, to finding stationary points (maxima, minima or in principle also saddle points) of any loss function.

In one aspect, a method is proposed which comprises determining initial values for the parameters (e.g. as default values, such as each parameter being zero), and iteratively updating the parameters by respective updates which are dependent upon one or more corresponding learning rate values. The learning rate value(s) are selected to vary inversely with (e.g. inversely proportionally to) at least one drift value indicative of discretization drift. Discretization drift refers to a difference between a update step to the parameters by gradient descent performed with continuous time dynamics based on the loss function, and a discrete update to the parameters by gradient descent based on the loss function, e.g. an incremental update by an amount which is a product of a learning rate value and the gradient of the loss function.

Having determined the learning rate value(s), respective updates (i.e. update amounts) for the each of the parameters are determined, based upon a product of the learning rate value(s) and a gradient of the loss function with respect to the respective parameter for current values of the parameters, and the parameters are updated by the determined respective updates. Optionally, as described below, the updates may include at least one additional term.

To put this another way, the updates to the parameters are based on learning rate value(s) which vary inversely with parameters which indicate, for the current parameters, an extent to which each updated parameter differs, when updated incrementally, from the value for that parameter which would have been obtained if the parameter had been updated by an update step of evolving in continuous time according to the gradient of a surface dependent upon the loss function. Such a continuous evolution would, in principle, allow the parameters to evolve to the saddle point without overshooting it. Thus, this choice of learning rate value(s) may be motivated by the observation that when the drift is low, incremental updates to the parameter values closely approximate the continuous evolution of the parameters, so that large updates are safe without overshooting the saddle point (e.g. it is safe for the learning rate value(s) to take a higher value than used in some known incremental gradient descent algorithms in which the learning rate value is constant throughout the iterative gradient descent algorithm); whereas when drift is high, and therefore an incremental updating of the parameters is expected to poorly approximate the continuous evolution, with a risk for example of overshooting the saddle point, the learning rate value(s) are preferably chosen to have smaller values.

In an example given below, the set of parameters (i.e. the parameter vector) derived in an iteration labelled by an integer index t (the first iteration being t=1), are denoted θₜ, based on the set of current parameters θₜ₋₁ derived in the previous iteration. The initial parameter vector (i.e. the set of initial values for the parameters) is denoted θ₀. The individual parameters may optionally be labelled by an integer index i, which may run from i=1, . . . , D where D denotes the number of parameters; thus, the current value of the i-th parameter may be denoted θₜ₋₁. The loss function of the current parameters is denoted E(θₜ₋₁), or more simply E. The learning rate value may be denoted h when there is only one such value, or {hᵢ} when there are D such values.

The drift value(s) may in principle be determined in any of multiple ways, but conveniently it (or they) are determined based on a Hessian matrix of the loss function based on second-order partial derivatives of the loss function for the current values of the parameters. Thus, in the example, the Hessian matrix is denoted ∇_{θ}²E. It may furthermore be based on the gradient of the loss function, e.g. ∇_{θ}E.

In one example, there may be only a single drift value and only a single learning value. The drift value may be determined based on a magnitude of the product of the Hessian matrix and the gradient of the loss function, i.e. in the example based on ∥∇_{θ}²E∇_{θ}E∥. Various algorithms are known to calculate this function, at least to approximate it to the extent that the result is indicative of the discretization drift. For example, a finite difference algorithm may be used to calculate ∥∇_{θ}²E∇_{θ}E∥, e.g. via the following approximation, which can be implemented for a neural network with only an additional backward pass: ∥∇_{θ}E∇_{θ}E∥≈(∇_{θ}²E(θ+ε∇_{θ}E)−V_{θ}E(θ))/ε.

It can be demonstrated, that this drift value may become small as the saddle point is approached, so if the learning rate value were simply set to be the reciprocal of ∥V_{θ}²E∇_{θ}E∥, the learning rate value would become very high, which might compromise the convergence to the saddle point. For that reason, in the case that the learning rate value is chosen to be a function of the reciprocal of the drift value, it is preferable to modify the drift value by including in its definition a term which increases the magnitude of the drift value if the gradient of the loss value becomes small. For example, the drift value(s) may be divided by the magnitude of the gradient of the loss function. Thus, the drift value may, in one option, be ∥V_{θ}²E∇_{θ}E∥/∥∇_{θ}E∥. Thus, the learning rate value is a function of the ratio of the magnitude of the gradient of the loss function and the magnitude of the product of the Hessian matrix and the gradient of the loss function. Note, however that this is just one choice, and although it has been determined experimentally to be an accurate one, other choices are possible. For example, in the definition of the drift value, ∥∇_{θ}²E∇_{θ}E∥ could alternatively be divided by tanh(β∥∇₀E∥), where β is a positive scalar value; such a term only has an influence when β∥|∇_{θ}E∥ is low.

Taking the case that the at least one learning rate value is a function of the ratio of the magnitude of the gradient of the loss function and the magnitude of the product of the Hessian matrix and the gradient of the loss function (e.g. the at least one learning rate value may be a function of ∥∇_{θ}E∥/∥∇_{θ}²E∇_{θ}E∥), the function may raise the ratio to a power p, where p is a positive scalar value. That is, h may be proportional to (∥∇_{θ}²E∇_{θ}E∥/∥∇_{θ}E∥). The case that p is 1 corresponds to the at least one learning rate value being inversely proportional to the drift value. However, p is not limited in this respect, and p may for example be chosen to be less than one. For example, it may be about 0.5 (e.g. in the range 0.3 to 0.7).

Alternatively, there may be a different drift value for each parameter, indicative of the discretization drift for that parameter. Similarly, there may be a respective learning rate value for each parameter, and the update to each parameter may be based upon a product of the respective learning rate value and the gradient of the loss function with respect to that parameter for the current values of the parameters. For example, the drift value for parameter i may, in the example, be based on the i-th component of ∇_{θ}²E∇_{θ}E. The learning value hᵢ may, for example, be a function which varies inversely with (e.g. inversely proportionally to) the i-th component of ∇_{θ}²E∇_{θ}E. More generally, the learning rate value for each parameter depends on the respective component of the product of (i) a Hessian matrix of the loss function based on second-order partial derivatives of the loss function for the current values of the parameters, and (ii) the gradient of the loss function with respect to the parameters. Using a different learning rate value for each parameter has been found, in some experiments, to lead to occasional large variations in parameter values; optionally, the amount that each parameter may be updated may be limited to a threshold value, e.g. a threshold which is the same for all parameters or which differs for different parameters.

As noted above, the updates to the parameters may be based on a product of the at least one learning rate value and a gradient of the loss function with respect to the respective parameter for current values of the parameters. In a simple case, θₜ may be formed from the current parameters θₜ₋₁ as θₜ=θₜ₋₁−h∇_{θ}E(θₜ₋₁), i.e. by updating the set of current parameters by an update amount which is the corresponding component of −h∇_{θ}E(θₜ₋₁). In the case of multiple learning rate values, the new parameters may be formed according to θ_{t,i}=θ_{t-1,i}−hᵢ(∇_{θ}E(θₜ₋₁))ᵢ, for each i. However, this is not the only possibility.

One example is for each iteration (except the first) to be based also on a momentum term, which is based on the current parameters and other parameters generated in the immediately preceding iteration. Thus, the respective updates to the parameters may be a sum of a respective momentum term (e.g. with the set of momentum terms being denoted mvₜ₋₁ where m is a scalar value and vₜ₋₁ is a vector having D components) and the term based on the product of the at least one learning rate and a gradient of the loss function with respect to the respective parameter for the current values of the parameters. There may be one momentum term for each parameter, and it is generated in each iteration by modifying a corresponding momentum term generated in the preceding iteration (e.g. by scaling it by the scalar m and modifying it based on the product of the at least one learning rate and the gradient of the loss function with respect to the respective parameter for the current values of the parameters). Note that the drift value is preferably not changed in the case that the updates also involve momentum terms: in other words, even in the case that the momentum term is present, the drift value, or each drift value, preferably still describes the discretization drift as between continuous-time gradient descent based on the loss function (without a momentum term), and incremental updates based on the loss function (without a momentum term). Thus, the learning rate value(s) are preferably still as described above.

For example, the updating of the current parameters θₜ₋₁ in iteration t (for each iteration but the first, t=1) may be:

θₜ=θₜ₋₁+mvₜ₋₁−h∇_{θ}E(θₜ₋₁),

where vₜ=mvₜ₋₁−h∇_{θ}E(θₜ₋₁), i.e. θₜ=θₜ₋₁+vₜ. Here v₀ may be set to any value, e.g. 0.

Alternatively, in the case of multiple learning rate values, the update may be:

θ_{t,i}=θ_{t-1,i}+mv_{t-1,i}−hᵢ(∇_{θ}E(θₜ₋₁))ᵢ

where v_{t,i}=mv_{t-1,i}−hᵢ(∇_{θ}E(θₜ₋₁))ᵢ and (∇_{θ}E(θₜ₋₁))ᵢ denotes the i-th component of ∇_{θ}E(θₜ₋₁).

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of an example machine learning system for determining values for parameters of machine learning model.

FIG. 2 is a flow diagram showing a procedure used by the machine learning system of FIG. 1 for determining the parameter values.

FIG. 3 is a flow diagram showing another procedure used by the machine learning system of FIG. 1 for determining the parameter values.

FIG. 4A is a graph showing training loss as a function of training iteration for a VGG model trained on CIFAR-10 using a version of the procedure of FIG. 3 compared with training loss for training the model using fixed learning rates.

FIG. 4B is similar to FIG. 4A except that the results are for a Resnet-18 model trained on CIFAR-10.

FIG. 4C is similar to FIG. 4A and FIG. 4B except that the results are for a Resnet-50 model.

### DETAILED DESCRIPTION

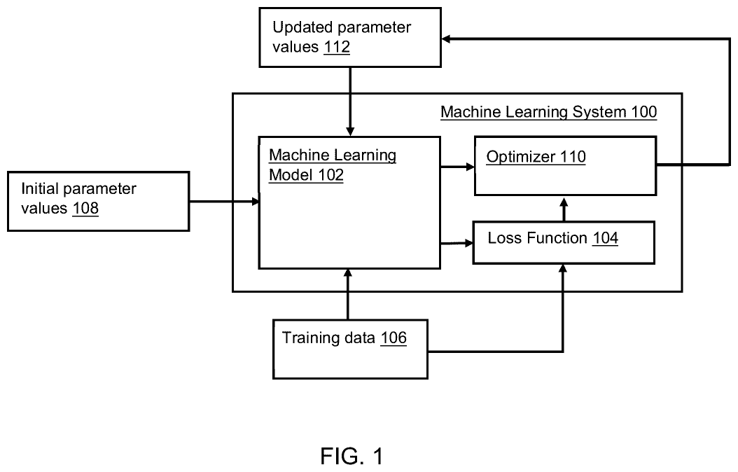

FIG. 1 illustrates an example of a machine learning system 100, which is an example of a system implemented as computer programs for one or more computers in one or more locations, in which the systems and techniques described below can be implemented.

The machine learning system 100 comprises a machine learning model 102 for performing a computational task in which inputs (input data items) are processed by the machine learning model 102 based on parameters θₜ of the machine learning model 102 to generate an output (output data item) for each of the inputs. For example, the machine learning model 100 may be a neural network defined by the parameters θₜ, in which case the parameters may define e.g. weights and/or biases of the neural network. In general, the machine learning model 102 can be configured to receive any kind of digital data input and to generate any kind of output, e.g. any kind of score, classification, clustering or regression output based on the input.

The performance of the machine learning model 102 in carrying out the computational task is evaluated using a loss function 104, E(θₜ₋₁), and training data 106 comprising training inputs (input data items) and a respective target (“ground truth”) output for each of the training inputs. The training inputs are each processed by the machine learning model 102 to generate a respective output (output data item) for each of the inputs. The loss function 104, E(θₜ₋₁), measures, for each of the training inputs, a discrepancy (e.g. difference) between (i) the output generated by the machine learning model 102 for the training input and (ii) the target output for the training input. The loss function 104 can be any machine learning loss function that is appropriate for the computational task that the machine learning model 102 is being trained to perform. For example, when the computational task is a classification task, the loss function can be the cross-entropy loss function.

The parameters θₜ of the machine learning model 102 are initialized from initial parameter values 108, θ₀, provided as an input to the machine learning model 102. In some implementations, the initial parameter values 108 may be obtained randomly, e.g. by sampling from an initial distribution of parameter values. Alternatively or additionally, the initial parameter values 108 may be obtained by training the machine learning model 102 to perform the computational task or another computational task.

The machine learning system 100 comprises an optimizer 110 for training the machine learning model 102. That is, the optimizer 110 is configured to iteratively update the parameters θₜ₋₁ of the machine learning model 102 to determine values for the parameters θₜ that define a stationary point (e.g. a minimum) of the loss function 104. The optimizer 110 may, for example, be configured to perform an iterative training process on batches of the training inputs. At each iteration, the optimizer 110 updates the parameters θₜ₋₁ of the machine learning model 102 to generate updated parameter values 112, θₜ, which are used for the subsequent iteration, e.g. for the next batch of training inputs. The optimizer 110 is configured to repeatedly update the parameters θₜ₋₁ of the machine learning model 102 in this way until one or more termination criteria for the training are satisfied, e.g. a specified number of training iterations has been performed, a specified amount of time has elapsed, or once a stationary point of the loss function 104 has been obtained to a predetermined level of accuracy.

Once the machine learning model 102 has been trained by the optimizer 110, the machine learning system 100 can provide the updated parameter values 112, 6t, specifying the machine learning model 102 for use in processing new inputs. That is, the machine learning system 100 can output, e.g. by outputting to a user device or by storing in a memory accessible by the system 100, the updated values of the parameters 112 for later use in processing inputs using the machine learning model 102.

Alternatively, or in addition to outputting the updated parameter values 112, 6t, the system 100 can: instantiate an instance of the machine learning model 102 having the updated values of the parameters 112; receive inputs to be processed, e.g., through an application programming interface (API) offered by the system; use the trained machine learning model 102 to process the received inputs to generate outputs and then provide the generated outputs in response to the received inputs.

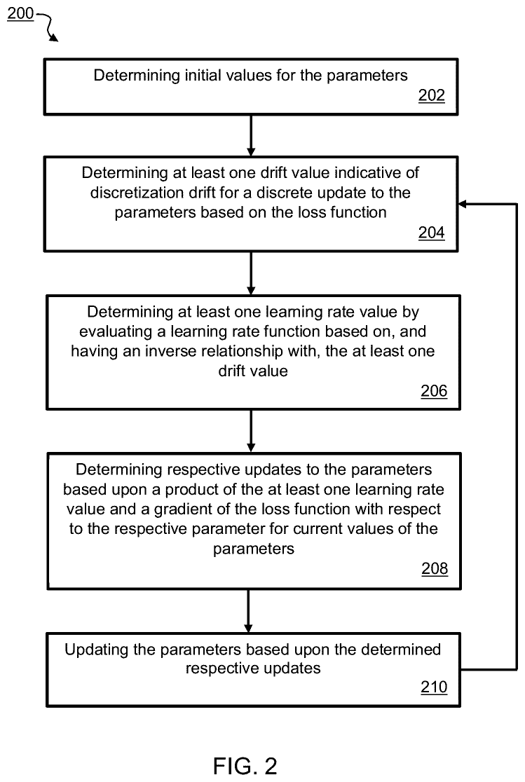

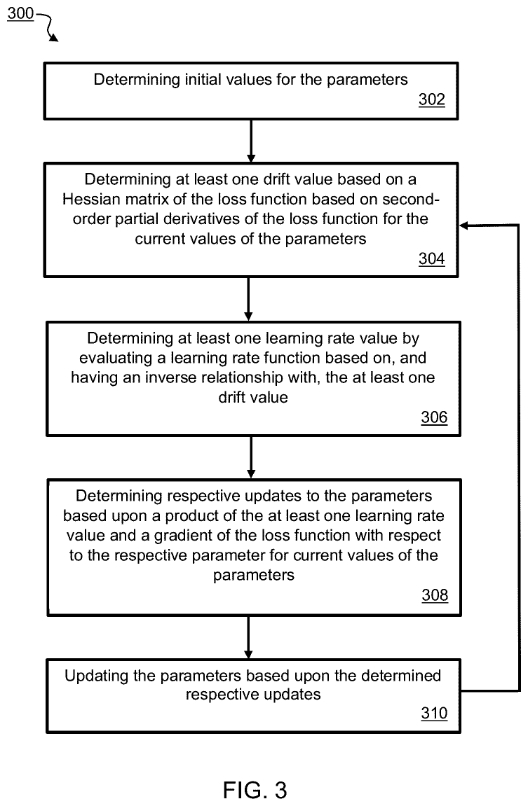

FIG. 2 and FIG. 3 are flow diagrams of exemplary processes 200, 300 that may be performed by a system of one or more computers located in one or more locations. For example, either of the processes 200, 300 may be performed by a machine learning system, e.g. the machine learning system 100 of FIG. 1, for training a machine learning model using a loss function.

With reference to the process 200 of FIG. 2, initial values θ₀ are determined for the parameters of the machine learning model (step 202) and the model trained by repeatedly performing the other steps 204, 206, 208, 210 of the process 200, which may be performed by an optimizer, such as the optimizer 110 of FIG. 1.

The optimizer determines at least one drift value indicative of discretization drift for a discrete update to the parameters θₜ₋₁ based on the loss function (step 204). The drift value may, for example, be determined based on a Hessian matrix of the loss function 104 based on second-order partial derivatives of the loss function for the current values of the parameters. For example, the drift value may be determined based on a magnitude of the product of the Hessian matrix and the gradient of the loss function, e.g. based on ∥∇_{θ}²E∇_{θ}E∥. As noted above, there may be a different drift value for each parameter, indicative of the discretization drift for that parameter θₜ₋₁.

The optimizer determines at least one learning rate value h by evaluating a learning rate function based on, and having an inverse relationship with, the at least one drift value (step 206). For example, the learning rate value h may be a function of the ratio of the magnitude of the gradient of the loss function and the magnitude of the product of the Hessian matrix and the gradient of the loss function, e.g. the at least one learning rate value may be a function of ∥∇_{θ}E∥/∥∇_{θ}²E∇_{θ}E∥.

The optimizer determines respective updates to the parameters θₜ₋₁ based upon a product of the at least one learning rate value and a gradient of the loss function with respect to the respective parameter for current values of the parameters (step 208). In some implementations, the updates to the parameters may be based on a product of the at least one learning rate value and a gradient of the loss function with respect to the respective parameter for current values of the parameters θₜ₋₁. For example, the updates may comprise update amounts which are the corresponding components of −h∇_{θ}E(θₜ₋₁). Where there is a different drift value for each parameter, there may be a respective learning rate value for each parameter, and the update to each parameter may be based upon a product of the respective learning rate value and the gradient of the loss function with respect to that parameter for the current values of the parameters. For example, the drift value for parameter i may, in the example, be based on the i-th component of ∇_{θ}²E∇_{θ}E. The learning value hᵢ may, for example, then be a function which varies inversely with (e.g. inversely proportionally to) the i-th component of ∇_{θ}²E∇_{θ}E.

The optimizer updates the parameters θₜ₋₁ based upon the determined respective updates (step 210). For example, θₜ may be formed from the current parameters θₜ₋₁ as θₜ=θₜ₋₁−h∇_{θ}E(θₜ₋₁), i.e. by updating the set of current parameters by an update amount which is the corresponding component of −h∇_{θ}E(θₜ₋₁). The update amount may, in some implementations, also include a momentum term, which is based on the current parameters and other parameters generated in the immediately preceding iteration.

The process 300 of FIG. 3 is the same as the process 200 of FIG. 2, except that: (i) the at least one drift value is specified as being determined based on a Hessian matrix ∇_{θ}²E of the loss function E(θₜ₋₁) based on second-order partial derivatives of the loss function for the current values of the parameters θₜ₋₁ (step 304); and (ii) determining respective updates to the parameters θₜ₋₁ is specified as being based upon a product of the at least one learning rate value and a gradient of the loss function with respect to the respective parameter for current values of the parameters θₜ₋₁.

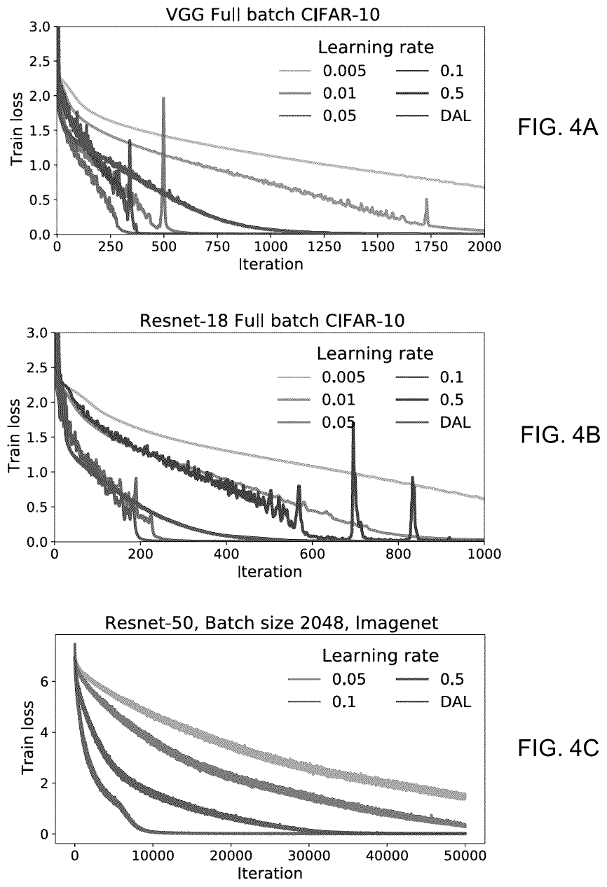

FIG. 4A is a graph showing training loss (vertical axis) as a function of training iteration (horizontal axis) for a VGG model trained on CIFAR-10 using a version of the process 300 of FIG. 3, which is referred to in FIG. 4A by the letters DAL, for Drift Adjusted Learning rate. In this example, the learning rate h(θₜ₋₁) for the t-th iteration, which is a function of the parameters θₜ₋₁ is determined by the equation:

$$h ( {θ}_{t - 1} ) = \frac{2}{‖ {∇}_{θ}^{2} E \hat{g} ( {θ}_{t - 1} ) ‖}$$

where ĝ(θₜ₋₁) is the normalized gradient ∇_{θ}E/∥∇_{θ}E∥. This learning rate may be used to ensure that the norm of the gradient descent update can be zero and that the magnitude of the parameter update depends on the gradient norm. The denominator of this learning rate ∥∇_{θ}²Eĝ(θₜ₋₁)| has been observed to have a strong correlation with the per iteration drift. The learning rate itself may be interpreted as approximating the “signal to noise ratio” of the learning signal obtained by minimizing the loss function E(θ) to the norm of the noise coming from the drift. Thus, the DAL rate may balance the gradient signal and the regularizing drift noise in gradient descent training.

The training loss for the DAL rate can be seen in FIG. 4A to decay to zero after around 1250 iterations, which is faster than the decays observed when a constant learning rate of 0.005 or 0.01 is used during training, but slower than the decays observed when a constant learning rate of 0.05, 0.1 or 0.5 is used during training. The process 300 of FIG. 3 can therefore be seen to allow the model to be trained effectively without requiring multiple training runs to determine an appropriate learning rate parameter. The process 300 also improves stability during training.

FIG. 4B and FIG. 4C are graphs showing similar results to FIG. 4A, with the training loss for the DAL rate decaying to zero after around 500 iterations and 10,000 iterations respectively. In the examples shown in FIGS. 4A-C, the process 300 has been observed to reduce the learning rate when the discretization drift is large and would otherwise be likely to cause instabilities, and increases the learning rate when the discretization drift is small, such that instabilities are unlikely to occur.

We now turn to a discussion of cases in which the present techniques may be used. This may include any task in which an optimization is to be performed. For example, the loss function may characterize a measure of the efficiency (e.g. the power consumption) of an item of industrial equipment (e.g. a data center or an engine) as a function of control settings of the industrial equipment (control settings of cooling equipment of the data center, or control settings of the engine). Thus, determining the minimum of the loss function corresponds to determining optimal settings which may be applied to the industrial equipment.

As noted, however, in a particular example, the parameters may comprise (or consist of) neural network parameters defining the functions performed by a plurality of nodes of a neural network. For example, the neural network may be a feed-forward neural network having a sequence of layers which each (except the first) process an output of the preceding layer of the sequence.

The neural network may be trained to perform a computational task on an input data item, to generate a corresponding output data item. The loss function is chosen based on the computational task the neural network is to perform. For example, it may be based on one or more training data items (representing possible input data items to the neural network), one or more corresponding target data items associated with the one or more training data items (i.e. the corresponding results of performing the computational task on the training data items), and one or more corresponding output data items generated by the neural network with the current parameters upon receiving the one or more training data items (i.e. the actual outputs of the neural network upon receiving the training data items). The loss function may indicate the discrepancy between the target data items and the output data items.

The training data items may, for example, consist of one of the following: image data items, encoding one or more still images; video data items, encoding a video sequence of images; audio data items, i.e. data representing sound (e.g. generated sound or sound received by a microphone); sensor data items, encoding the output of at least one sensor describing a state of an environment; or text data items encoding a sample of natural language text. When the trained neural network is in use and being used to perform the computational task, the input data items to the neural network are data items of the same sort (i.e. data items consisting of data in the same one of the five categories).

In certain cases, the training data items, and the input data items when the network is in use following training to perform the computational task, may comprise data items which comprise data in more than one of these categories (e.g. data items including both text data and associated image and/or video and/or sound data, such as text describing, or asking a question about, content of the image and/or video and/or sound data; or data items including associated image and/or video data and associated sound data, such as sounds encoding a voice describing, or asking a question about, content of the image and/or video data). Neural networks configured to receive input data items which comprise data in more than one format (e.g. more than one of the five categories listed above), that is “multi-modal inputs”, are referred to as “multi-modal networks”.

The neural network-based system can be trained to perform classification type tasks. Thus, the output data item generated by the neural network upon receiving one of the input data items is data indicating that the input data item is in a specified one of a plurality of classes. The target data items and output data items may be in the form of a one-hot vector. That is, a vector whereby the element corresponding to the correct class/selection is set to 1 and all other elements set to 0. The loss function may be based on a sum over the training data items of a dot-product between one-hot vectors representing the target data item and the output data item.

For example, where the training data item is image data, the neural network-based system can be trained for object classification, that is to predict or determine an object that is present in the image data. In another example, the task may be object detection, that is, to determine whether an aspect of the image data, such as a pixel or region, is part of an object. Another image-based task may be pose estimation of an object. The training data item may be a video data item. Possible video tasks include action recognition, that is, to determine what action is being performed in a video or a segment (aspect) of a video, and action detection to determine whether an action is being performed in a segment of video. The training data item may be an audio data item. Possible audio tasks on audio data items include speech recognition and speaker recognition amongst others.

In the case of an image data item, which as used here includes a video data item, the tasks may include any sort of image processing or vision task such as an image classification or scene recognition task, an image segmentation task e.g. a semantic segmentation task, an object localization or detection task, a depth estimation task. When performing such a task the input may comprise or be derived from pixels of the image. For an image classification or scene recognition task the output may comprise a classification output providing a score for each of a plurality of image or scene categories e.g. representing an estimated likelihood that the input data item or an object or element of the input data item, or an action within a video data item, belongs to a category. For an image segmentation task the output may comprise, for each pixel, an assigned segmentation category or a probability that the pixel belongs to a segmentation category, e.g. to an object or action represented in the image or video. For an object localization or detection task the output may comprise data defining coordinates of a bounding box or region for one or more objects represented in the image. For a depth estimation task the output may comprise, for each pixel, an estimated depth value such that the output pixels define a (3D) depth map for the image. Such tasks may also contribute to higher level tasks e.g. object tracking across video frames; or gesture recognition i.e. recognition of gestures that are performed by entities depicted in a video.

Another example image processing task may include an image keypoint detection task in which the output comprises the coordinates of one or more image keypoints such as landmarks of an object represented in the image, e.g. a human pose estimation task in which the keypoints define the positions of body joints. A further example is an image similarity determination task, in which the output may comprise a value representing a similarity between two images, e.g. as part of an image search task.

The neural network-based system can be configured to receive any kind of digital data input (as the input data item) and to generate any kind of score, classification, or regression output based on the input.

For example, if the inputs to the neural network-based system are images or features that have been extracted from images, the output generated by the neural network-based system for a given image may be scores for each of a set of object categories, with each score representing an estimated likelihood that the image contains an image of an object belonging to the category.

As another example, if the inputs to the neural network-based system are Internet resources (e.g., web pages), documents, or portions of documents or features extracted from Internet resources, documents, or portions of documents, the output generated by the neural network for a given Internet resource, document, or portion of a document may be a score for each of a set of topics, with each score representing an estimated likelihood that the Internet resource, document, or document portion is about the topic.

As another example, if the inputs to the neural network-based system are features of an impression context for a particular advertisement, the output generated by the neural network may be a score that represents an estimated likelihood that the particular advertisement will be clicked on.

As another example, if the inputs to the neural network-based system are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network-based system is a sequence of text in one language, the output generated by the neural network may be a score for each of a set of pieces of text in another language, with each score representing an estimated likelihood that the piece of text in the other language is a proper translation of the input text into the other language.

As another example, if the input to the neural network-based system is an audio data item which is a sequence representing a spoken utterance, the output generated by the neural network may be a score for each of a set of pieces of text, each score representing an estimated likelihood that the piece of text is the correct transcript for the utterance. As another example, if the input to the neural network-based system is a sequence representing a spoken utterance, the output generated by the neural network-based system can indicate whether a particular word or phrase (“hotword”) was spoken in the utterance. As another example, if the input to the neural network-based system is a sequence representing a spoken utterance, the output generated by the neural network-based system can identify the natural language in which the utterance was spoken. Thus in general the network input may comprise audio data for performing an audio processing task and the network output may provide a result of the audio processing task e.g. to identify a word or phrase or to convert the audio to text.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

In another example, the output data items may be data for controlling an agent, e.g. in a reinforcement learning system. The input data items are “observations” of the state of an environment. The output data items may comprise data indicative of an action to be performed by the agent or a selection of a policy from which actions to be performed by the agent are selected. The reinforcement learning system may proceed to select an action and the agent may proceed to carry out the action.

In implementations, the observation may relate to a real-world environment and the selected action relates to an action to be performed by a mechanical agent, such as an electromechanical agent (e.g. a robot), which moves (by translation and/or by reconfiguration of the agent) within the environment. The agent may interact with the environment to accomplish a task, e.g. a robot manipulating objects in the environment, or an autonomous or semi-autonomous land or air or water vehicle navigating through the environment. In another example, the agent may be a control system for an industrial facility.

The input data items may be a sequence of observations or other data characterizing states of an environment, e.g. a video sequence, and the output data items defines an action to be performed by the agent in response to the most recent input data item in the sequence.

At each time step, the state of the environment at the time step depends on the state of the environment at the previous time step and the action performed by the agent at the previous time step.

In general the observations (input data items) may include, for example, one or more of images, object position data, and sensor data to capture observations as the agent interacts with the environment, for example sensor data from an image, distance, or position sensor or from an actuator. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. For example in the case of a robot the observations may include data characterizing the current state of the robot, e.g. one or more of: joint position, joint velocity, joint force, torque or acceleration, and global or relative pose of a part of the robot such as an arm and/or of an item held by the robot. The observations may also include, for example, sensed electronic signals such as motor current or a temperature signal; and/or image or video data for example from a camera or a LIDAR sensor, e.g., data from sensors of the agent or data from sensors that are located separately from the agent in the environment. As used herein an image includes a point cloud image e.g. from a LIDAR sensor.

The actions may comprise control inputs to control a physical behavior of the mechanical agent e.g. robot, e.g., torques for the joints of the robot or higher-level control commands; or to control the autonomous or semi-autonomous land or air or sea vehicle, e.g., torques to the control surface or other control elements of the vehicle or higher-level control commands. In other words, the actions can include for example, position, velocity, or force/torque/acceleration data for one or more joints of a robot or parts of another mechanical agent. Action data may include data for these actions and/or electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation e.g. steering, and movement e.g. braking and/or acceleration of the vehicle.

In such applications the task-related rewards may include a reward for approaching or achieving one or more target locations, one or more target poses, or one or more other target configurations, e.g. to reward a robot arm for reaching a position or pose and/or for constraining movement of a robot arm. A cost may be associated with collision of a part of a mechanical agent with an entity such as an object or wall or barrier. In general a reward or cost may be dependent upon any of the previously mentioned observations e.g. robot or vehicle positions or poses. For example in the case of a robot a reward or cost may depend on a joint orientation (angle) or speed/velocity e.g. to limit motion speed, an end-effector position, a center-of-mass position, or the positions and/or orientations of groups of body parts; or may be associated with force applied by an actuator or end-effector, e.g. dependent upon a threshold or maximum applied force when interacting with an object; or with a torque applied by a part of a mechanical agent. In another example a rewards or cost may depend on energy or power usage, motion speed, or a positions of e.g. a robot, robot part or vehicle.

The output data may be for selecting an option for controlling an agent in a reinforcement learning system, wherein the selected option comprises a sequence of primitive actions performed by the agent under control of a respective option policy neural network. A primitive action may be an action performed by the agent at a time step. In implementations a manager neural network selects from options (or primitive actions) to perform a task. Training the neural network-based system may result in fine-tuning a set of pre-trained skills for particular tasks. Further details relating to skills in a reinforcement learning systems and learning of skills can be found in Eysenbach et al., “Diversity is all you need: learning skills without a reward function”, arXiv:1802.06070, available at: https://arxiv.org/abs/1802.06070 which is hereby incorporated by reference in its entirety.

In the above described applications the same observations, actions, rewards and costs may be applied to a simulation of the agent in a simulation of the real-world environment. Once the system has been trained in the simulation, e.g. once the neural networks of the system/method have been trained, the system/method be used to control the real-world agent in the real-world environment. That is, control signals generated by the system/method may be used to control the real-world agent to perform a task in the real-world environment in response to observations from the real-world environment. Optionally the system/method may continue training in the real-world environment.

In some applications the environment is a networked system and the actions comprise configuring settings of the networked system that affect the energy efficiency or performance of the networked system. The networked system may be e.g. an electric grid or a data center.

In some applications the agent may be a static or mobile software agent i.e. a computer programs configured to operate autonomously and/or with other software agents or people to perform a task. For example the environment may be a circuit or an integrated circuit routing environment and the agent may be configured to perform a routing task for routing interconnection lines of a circuit or of an integrated circuit e.g. an ASIC. The reward(s) and/or cost(s) may then be dependent on one or more routing metrics such as interconnect length, resistance, capacitance, impedance, loss, speed or propagation delay; and/or physical line parameters such as width, thickness or geometry, and design rules; or may relate to a global property such as operating speed, power consumption, material usage, cooling requirement, or level of electromagnetic emissions. The observations may be e.g. observations of component positions and interconnections; the actions may comprise component placing actions e.g. to define a component position or orientation and/or interconnect routing actions e.g. interconnect selection and/or placement actions.

In some applications the agent may be an electronic agent and the observations may include data from one or more sensors monitoring part of a plant or service facility such as current, voltage, power, temperature and other sensors and/or electronic signals representing the functioning of electronic and/or mechanical items of equipment. The agent may control actions in a real-world environment including items of equipment, for example in a facility such as: a data center, server farm, or grid mains power or water distribution system, or in a manufacturing plant or service facility. The observations may then relate to operation of the plant or facility, e.g. they may include observations of power or water usage by equipment, or observations of power generation or distribution control, or observations of usage of a resource or of waste production. The actions may include actions controlling or imposing operating conditions on items of equipment of the plant/facility, and/or actions that result in changes to settings in the operation of the plant/facility e.g. to adjust or turn on/off components of the plant/facility. The reward(s) and/or cost(s) may include one or more of: a measure of efficiency, e.g. resource usage; a measure of the environmental impact of operations in the environment, e.g. waste output; electrical or other power or energy consumption; heating/cooling requirements; resource use in the facility e.g. water use; or a temperature of the facility or of an item of equipment in the facility.

In some applications the environment may be a data packet communications network environment, and the agent may comprise a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) or cost(s) may be defined in relation to one or more of the routing metrics i.e. to maximize or constrain one or more of the routing metrics.

In some other applications the agent is a software agent which manages distribution of tasks across computing resources e.g. on a mobile device and/or in a data center. In these implementations, the observations may include observations of computing resources such as compute and/or memory capacity, or Internet-accessible resources; and the actions may include assigning tasks to particular computing resources. The reward(s) or cost(s) may be to maximize or limit one or more of: utilization of computing resources, electrical power, bandwidth, and computation speed.

In some other applications the environment may be an in silico drug design environment, e.g. a molecular docking environment, and the agent may be a computer system for determining elements or a chemical structure of the drug. The drug may be a small molecule or biologic drug. An observation may be an observation of a simulated combination of the drug and a target of the drug. An action may be an action to modify the relative position, pose or conformation of the drug and drug target (or this may be performed automatically) and/or an action to modify a chemical composition of the drug and/or to select a candidate drug from a library of candidates.

One or more rewards or costs may be defined based on one or more of: a measure of an interaction between the drug and the drug target e.g. of a fit or binding between the drug and the drug target; an estimated potency of the drug; an estimated selectivity of the drug; an estimated toxicity of the drug; an estimated pharmacokinetic characteristic of the drug; an estimated bioavailability of the drug; an estimated ease of synthesis of the drug; and one or more fundamental chemical properties of the drug. A measure of interaction between the drug and drug target may depend on e.g. a protein-ligand bonding, van der Waal interactions, electrostatic interactions, and/or a contact surface region or energy; it may comprise e.g. a docking score.

In some other applications the environment is an Internet or mobile communications environment and the agent is a software agent which manages a personalized recommendation for a user. The observations may comprise previous actions taken by the user, e.g. features characterizing these; the actions may include actions recommending items such as content items to a user. The reward(s) or cost(s) may be to maximize or constrain one or more of: an estimated likelihood that the user will respond favorably to being recommended the (content) item, a suitability unsuitability of one or more recommended items, a cost of the recommended item(s), and a number of recommendations received by the user, optionally within a time span.

In another example, the updates to the parameters of the neural network are performed jointly with (i.e. substantially simultaneously with or interleaved with) updates to second parameters which define a second neural network. The joint updates constitute an adversarial learning method in an adversarial model including the neural network and the second neural network. The training is performed to minimize an objective function having a plurality of loss function components, at least one of the loss function components being a function of both the parameters and the second parameters, where optimizing one of the loss function components with respect to the numerical parameters moves another of the loss function components away from its optimal value.

The adversarial model may be any type of adversarial model. In particular, it may be selected from the group including generative adversarial networks (GANs), proximal gradient TD learning, multi-level optimization (Pfau and Vinyals, 2016), synthetic gradients (Jaderberg et al, 2017), hierarchical reinforcement learning (Wayne and Abbot, 2014; Vezhnevets et al, 2017), curiosity networks (as proposed by Pathak et al 2017), and imaginative networks (as proposed by Racaniere et al, 2017). Typically, these adversarial models contain a plurality of neural networks and they are trained by an objective function which causes these networks to compete against each other. The training is typically designed to reach the Nash equilibrium for this competition. Input data items to at least one of the neural networks of the adversarial network may be data obtained from the real world (e.g. sensor data from a sensor such as a camera or video camera, or sound captured by a microphone) or samples of natural language (e.g. in written form). Alternatively or additionally, outputs from at least one of the neural networks may be data (e.g. image data, video data and/or sound data) which mimics data obtained from the real world. Similarly, outputs from at least one of the neural networks of the adversarial network may be control data to influence the real world (e.g. to control at least one agent in the real world such as an electromechanical agent moving (by translation and/or change of configuration) in the real world), and/or images and/or sound data, or samples of natural language (e.g. in written form). For example, one of the neural networks may be configured to generate output data which mimics data obtained from the real world, and/or which is control data, and the other of the neural networks may be configured to process the output data of the other neural network, to generate a classification or score for that output data.

According to a further aspect, there is provided a method of performing a computational task using a neural network trained using a training method described above, e.g. a method of classifying input data items or of controlling an agent of the type described above, e.g. to move in and/or interact with in a real-world environment.

According to another aspect, there is provided a system comprising one or more computers and one or more storage devices storing instructions that when executed by the one or more computers cause the one or more computers to perform the operations of the respective method described above.

According to a further aspect, there is provided one or more computer storage media storing instructions that when executed by one or more computers cause the one or more computers to perform the operations of the respective method described above.

The subject matter described in this specification can be implemented in particular embodiments so as to realize the advantage of training neural networks with rapid convergence to the stationary points of the loss function. This has been confirmed experimentally. It permits a reduction of the computational resources (e.g. the number of operations, and running time) required to train a neural network. Furthermore, even in complex cases, convergence to a good solution is more likely than with known training methods, resulting in neural networks which perform technical tasks more accurately, e.g. with less runtime error in performing the computational task.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. What is claimed is:

1. A computer-implemented method for determining, for a loss function which is a function of a parameter vector comprising a plurality of parameters, values for the parameters for which the parameter vector is a stationary point of the loss function, the method comprising:
determining initial values for the parameters;
and repeatedly updating the parameters by:
(a) determining at least one drift value based on a Hessian matrix of the loss function based on second-order partial derivatives of the loss function for current values of the parameters;
(b) determining at least one learning rate value by evaluating a learning rate function based on, and having an inverse relationship with, the at least one drift value;
(c) determining respective updates to the parameters based upon a product of the at least one learning rate value and a gradient of the loss function with respect to the respective parameter for current values of the parameters; and
(d) updating the parameters based upon the determined respective updates.

2. The method of claim 1, in which the at least one drift value is determined based on a magnitude of the product of the Hessian matrix and the gradient of the loss function.

3. The method of claim 1, in which at least one drift value is determined including a term which increases a magnitude of the drift value when the magnitude of the gradient of the loss function becomes small.

4. The method of claim 3, in which the at least one learning rate value is a function of a ratio of the magnitude of the gradient of the loss function and the magnitude of the product of the Hessian matrix and the gradient of the loss function.

5. The method of claim 4, in which the function raises the ratio to a power p.

6. The method of claim 5, in which the power p is less than one.

7. The method of claim 1, in which there is a respective learning rate value for each parameter, the update to each parameter being based upon a product of the respective learning rate value and the gradient of the loss function with respect to that parameter for the current values of the parameters.

8. The method of claim 7, in which the learning rate value for each parameter depends on a respective component of the product of (i) a Hessian matrix of the loss function based on second-order partial derivatives of the loss function for the current values of the parameters, and (ii) the gradient of the loss function with respect to the parameters.

9. The method of claim 1, in which the respective updates to the parameters are a sum of a respective momentum term and a term based on the product of the at least one learning rate and a gradient of the loss function with respect to the respective parameter for the current values of the parameters, the respective momentum terms being updated in each iteration.

10. The method of claim 1, in which the parameters comprise neural network parameters defining the functions of a plurality of nodes of a neural network, the neural network being configured to perform a function on an input data item to generate a corresponding output data item, the loss function being indicative of the ability of the neural network to perform a computational task on input data items.

11. The method of claim 10, in which the loss function is based on one or more training data items, one or more corresponding target data items associated with the one or more training data items, and one or more corresponding output data items generated by the neural network upon receiving the one or more training data items.

12. The method of claim 11, in which the training data items comprise:
image data items;
video data items;
audio data items;
sensor data items, encoding the output of at least one sensor describing a state of an environment; or
text data items encoding a sample of natural language text.

13. The method of claim 10, in which the output data item generated by the neural network upon receiving one of the input data items is data indicating that the input data item is in a specified one of a plurality of classes.

14. The method of claim 10, in which the output data item is input data for a controller configured to generate control data for controlling an agent to perform an action in an environment, the output data item being indicative of the action to be performed by the agent or a selection of a policy from which actions to be performed by the agent are selected.

15. The method of claim 14, in which the environment is a real-world environment, and the agent is an electromechanical agent configured to operate in the real-world environment based on the control data.

16. A method of claim 10, in which the neural network includes a sequence of a plurality of layers.

17. The method of claim 16, in which at least one of the layers is a convolutional layer.

18. The method of claim 10, wherein the neural network is based upon a ResNet architecture.

19. A system comprising:
one or more computers; and
one or more storage devices communicatively coupled to the one or more computers, wherein the one or more storage devices store instructions that, when executed by the one or more computers, cause the one or more computers to perform operations for determining, for a loss function which is a function of a parameter vector comprising a plurality of parameters, values for the parameters for which the parameter vector is a stationary point of the loss function, the operations comprising:
determining initial values for the parameters;
and repeatedly updating the parameters by:
(a) determining at least one drift value based on a Hessian matrix of the loss function based on second-order partial derivatives of the loss function for current values of the parameters;
(b) determining at least one learning rate value by evaluating a learning rate function based on, and having an inverse relationship with, the at least one drift value;
(c) determining respective updates to the parameters based upon a product of the at least one learning rate value and a gradient of the loss function with respect to the respective parameter for current values of the parameters; and
(d) updating the parameters based upon the determined respective updates.

20. One or more non-transitory computer storage media storing instructions that when executed by one or more computers cause the one or more computers to perform operations for determining, for a loss function which is a function of a parameter vector comprising a plurality of parameters, values for the parameters for which the parameter vector is a stationary point of the loss function, the operations comprising:
determining initial values for the parameters;
and repeatedly updating the parameters by:
(a) determining at least one drift value based on a Hessian matrix of the loss function based on second-order partial derivatives of the loss function for current values of the parameters;
(b) determining at least one learning rate value by evaluating a learning rate function based on, and having an inverse relationship with, the at least one drift value;
(c) determining respective updates to the parameters based upon a product of the at least one learning rate value and a gradient of the loss function with respect to the respective parameter for current values of the parameters; and
(d) updating the parameters based upon the determined respective updates.
